(19) United States
(12) Patent Application Publication
(10) Pub. No.: US 2009/0287525 A1
(43) Pub. Date: Nov. 19, 2009

(54) System and Method For Safety Management

(75) Inventors: Donna Cangelosi Crossman, Scotia, NY (US); Richard Crossman, Scotia, NY (US); Julie Lovely, West Bridgewater, MA (US)

Correspondence Address: Julie Lovely, 150 West Street, West Bridgewater, MA, 02379, US

(73) Assignee: RPT SAFETY & HEALTH SERVICES, INC., West Bridgewater, MA (US)

(21) Appl. No.: 12/467,100

(22) Filed: May 15, 2009

Related U.S. Application Data
(60) Provisional application No. 61/053,384, filed on May 15, 2008.

(51) Int. Cl. G06Q 10/00; G06Q 50/00; G06N 5/02

(52) U.S. Cl. 705/8; 705/7; 706/47; 705/11

(57) ABSTRACT

A computerized method of safety improvement and management within an organization may include receiving a first set of data from the organization over a global communication network. The first set of data may include organizational data, safety incident data, safety performance data, and/or workplace hazard data. The computerized method may also perform, within a computer process, a needs assessment for the organization by analyzing the first set of data. The needs assessment may generate information regarding at existing safety issues, gaps within the organization's safety performance, and/or gaps within the organization's safety procedures. The computerized method may then, within a computer process create a safety program for the organization. The safety program may be based, at least in part upon the needs assessment and may include solutions to the existing safety issues and/or gaps within the organization's safety performance and procedures.

### PRIORITY

This patent application claims priority from provisional United States patent application:

U.S. Patent Application No. 61/053,384, filed May 15, 2008, entitled, “System and Method for Safety Management,” assigned docket number RPT-001, and naming Donna Cangelosi Crossman, Richard Crossman, and Julie Lovely as inventors, the disclosure of which is incorporated herein, in its entirety, by reference.

### FIELD OF THE INVENTION

The invention generally relates to safety, more particularly, the invention relates to systems and methods for safety management.

### BACKGROUND

Except for the self-employed, all U.S. workers are protected by safety standards established by the Occupational Safety and Health Administration (OSHA), a governmental arm of the Department of Labor (DOL). Businesses consisting of more than 11 employees are obligated to report to OSHA workplace accident, illness, and injury data. Yet, despite a gradual decrease in fatalities and injuries over the past several years, the national cost of workplace accidents continues to increase, growing 7.9% between 1998 and 2004 to a total of $48.6 billion. In addition to the direct costs of workplace accidents (increased workers' compensation premiums, civil liability damages, litigation expenses), indirect costs (decreased productivity, lower employee morale and commitment, damaged public image, etc. . . . ) are estimated to be 20 times the direct cost. In fact, the costs of the top three workplace injuries (overexertion, falls, and bodily reaction) are growing at a rate faster than inflation.

### SUMMARY OF THE INVENTION

In accordance with illustrative embodiments of the present invention, a computerized method of safety improvement and management includes receiving a first set of data from the organization, performing a needs assessment, and creating a safety program. The first set of data may be received over a global communication network and may include data relating to the organization, safety incident(s), safety performance, and workplace hazards. The method may perform the needs assessment within a computer process and by analyzing the first set of data. The needs assessment may generate information regarding existing safety issues, gaps within the organization's safety performance, and gaps within the organization's safety procedures, for example. The method may also create the safety program within a computer process. The safety program may be based, at least in part upon, the needs assessment and may include solutions to the existing safety issues and/or gaps within the organization's safety performance and procedures.

The computerized method may then evaluate, within a computer process, the implementation and performance of the safety improvement program. The computerized method may also calculate, within a computer process, a financial impact on the organization. The financial impact on the organization may include the estimated costs for program development and implementation, estimated costs for addressing the gaps within the organization's safety performance and/or procedures, and estimated costs savings once the program is implemented.

The method may further include automatically prompting the organization for new data. The new data may include, for example, updated safety incident data, updated safety performance data, and new workplace hazard data. The computerized method may then receive the new set of data from the organization over a global communication network, and analyze, within a computer process, the new data to determine new and potential safety issues and gaps. The method may also automatically generate, within a computer process, solutions to the new and potential safety issues and a solution implementation procedure. The solution implementation procedure may help the organization implement the solutions to the new and potential safety issues. The method may then transmit, over the global communications network, the solution implementation procedure to the organization. The organization may then perform the solution implementation procedure. The method may also perform, within a computer process, a cause analysis on the new data to determine a root cause of the new safety issues and gaps. The solutions to the new and potential safety issues may be based, at least in part, upon the root cause of the new safety issues and gaps.

In accordance with additional embodiments, a system for managing workplace safety may include means for creating a learning organization within an organization, and means for periodically evaluating the organization. The learning organization may generate a first set of data that includes information related to the organization's safety performance and existing safety issues. The learning organization may allow the organization to learn from safety successes and safety failures and maintain balanced workplace safety performance. The means for periodically evaluating the organization may detect new safety issues and generate a second set of data that includes information regarding the new safety issues. The system may also include means for determining solutions to existing safety issues and new safety issues using the first and second data sets.

In some embodiments, the means for creating a learning organization may include means for performing a needs assessment, means for designing a safety program, and means for implementing the safety program (e.g., to create a learning organization). The means for performing the needs assessment may generate the first set of data and identify the existing safety issues and gaps between the organization's safety performance and an ideal safety system. The safety program designed by the means for designing a safety program may address the gaps between the organization's safety performance and the ideal safety system.

In accordance with further embodiments, the means for performing a needs assessment may also include means for performing at least one of a safety audit, a hazard analysis, and a performance analysis to determine a current state of safety. The means for performing a needs assessment may also include means for comparing the current state of safety against at least one of a plurality of cultural and behavioral factors. The plurality of cultural and behavioral factors may include information, resources, incentives, knowledge, capacity, and/or motivation.

In accordance with other embodiments, the means for determining solutions to existing safety and new safety issues may include means for identifying at least one problem within the organization's safety performance, means for conducting a cause analysis, a means for developing a solution to the at least one problem, and a means for developing a solution implementation procedure. The means for conducting a cause analysis may determine the root cause of the at least one problem within the organization's safety performance generate cause data. The means for developing a solution to the at least one problem may use the cause data to develop the solution. The solution implementation procedure may allow the organization to implement the solution to the at least one problem.

The system (e.g., the means for determining solutions) may also have a means to calculate a financial impact on the organization. The financial impact may be based, at least in part, upon the determined solutions to existing safety issues and the first set of data. The financial impact may be further based upon the second set of data (e.g., in addition to the determined solutions to existing safety issues and the first set of data).

In accordance with still further embodiments of the present invention, a computer program product is provided. The computer program product may be for use on a computer system for managing workplace safety within an organization, and may include a computer usable medium having computer readable program code thereon. The computer readable program code may include program code for helping the organization create a learning organization within an organization. The learning organization may generate a first set of data that includes information related to the organization's safety performance and existing safety issues, and also allow the organization to learn from safety successes and safety failures and maintain balanced workplace safety performance.

The computer program product may also include program code for periodically evaluating the organization to detect new safety issues and generate a second set of data that includes information regarding the new safety issues. The computer program product may also include program code for determining solutions to existing safety issues and new safety issues using the first and second data sets.

In accordance with other embodiments, the computer program product may also include computer code for performing a needs assessment, computer code for designing a safety program, and computer code for implementing the safety program. The needs assessment may generate the first set of data and identify the existing safety issues and gaps within the organization's safety performance. The safety program may address the gaps within the organization's safety performance. The computer program product may also include computer code for evaluating the organization.

The computer code for performing a needs assessment may include computer code for performing at least one of a safety audit, a hazard analysis, and a performance analysis to determine a current state of safety, and computer code for comparing the current state of safety against at least one of a plurality of cultural and behavioral factors. The plurality of cultural and behavioral may include, for example, information, resources, incentives, knowledge, capacity, and motivation.

The computer code for determining solutions to existing safety and new safety issues may include computer code for identifying at least one problem within the organization's safety performance, and computer code for conducting a cause analysis. The cause analysis may determine a root cause of the at least one problem and generate cause data. The computer program product may also include computer code for developing a solution to the problem(s) and computer code for developing a solution implementation procedure. The solution may be based, at least in part, upon the cause data. The solution implementation procedure may allow the organization to implement the solution to the problem(s).

The first set of data may be collected by analyzing the organization's records and reports within a computer process and/or receiving data input by the organization into at least one user interface template within a graphical interface. The computer program product may also include computer code for determining a financial impact on the organization that may be based upon the determined solutions to existing safety issues, the first set of data, and/or the second set of data.

In accordance with additional embodiments, a method for managing workplace safety includes creating a learning organization within an organization, and periodically evaluating the organization to detect new safety issues. The learning organization may generate a first set of data that includes information related to the organization's safety performance and existing safety issues. The learning organization may also allow the organization to learn from safety successes and safety failures and maintain balanced workplace safety performance. The method may also periodically evaluate the organization to detect new safety issues and generate a second set of data that includes information regarding the new safety issues. The method may then determine solutions to the existing and new safety issues using the first and second data sets. The first set of data may be collected in a variety of ways including, but not limited to, performing interviews with members of the organization, examining of the organization's records, surveying members and affiliates of the organization, and directly observing the organization.

In accordance with other embodiments of the present invention, the method may also include performing a needs assessment, designing a safety program, implementing the safety program, and evaluating the creation of the learning organization (e.g., to ensure that the learning organization has been achieved). Performing the needs assessment may generate the first set of data and identify the existing safety issues and gaps between the organization's safety performance and an ideal safety system. The designed safety program may address the gaps between the organization's safety performance and the ideal safety system.

In accordance with still further embodiments of the present invention, performing a needs assessment may include performing one or more of a of a safety audit, a hazard analysis, and a performance analysis to determine a current state of safety. Performing a needs assessment may also include comparing the current state of safety against at least one of a plurality of cultural and behavioral factors. The cultural and behavioral factors may include, but are not limited to, information, resources, incentives, knowledge, capacity, and motivation.

In accordance with additional embodiments of the present invention, determining solutions to existing and new safety issues may include identifying problem(s) within the organization's safety performance, and conducting a cause analysis to determine the root cause of the problem(s) within the organization's safety performance. The cause analysis may generate cause data. Determining solutions may also include developing a solution to the problem(s) using the cause data, and developing a solution implementation procedure. The solution implementation procedure may allow the organization to implement the solution to the problem(s).

In accordance with further embodiments, the method may also determine a financial impact on the organization. The financial impact may be based on the determined solutions to existing safety issues and the first set of data. The financial impact may also be based on the second set of data (e.g., in addition to the determined solutions to existing safety issues and the first set of data).

### BRIEF DESCRIPTION OF THE DRAWINGS

The foregoing features of the invention will be more readily understood by reference to the following detailed description, taken with reference to the accompanying drawings, in which:

FIG. 1 schematically shows an embodiment of the system and method for safety management in accordance with embodiments of the present invention.

FIG. 2 schematically shows a flowchart of a method of implementing the failsafe workplace model shown in FIG. 1 in accordance with embodiments of the present invention.

FIG. 3 is a block diagram of a system implementing various methods in accordance with embodiments of the present invention.

FIG. 4 is a flowchart of a computerized method of safety management and improvement, in accordance with embodiments of the present invention.

### DESCRIPTION OF ILLUSTRATIVE EMBODIMENTS

In illustrative embodiments of the present inventions, a comprehensive safety management and improvement system and method manages safety within an organization. Exemplary embodiments of the safety management and improvement system and method may be both behavioral and cultural in nature, and may improve safety within the organization, improve the organization's safety culture, and may positively impact the organizational bottom line.

As all successful organizations demonstrate a keen willingness to learn from their successes and failures, embodiments of the present invention may also be underpinned by a strategy of learning. Research has repeatedly illustrated that the strength of an organization is only as robust as its ability to engage in collaborative learning. In accordance with embodiments of the present invention, learning (and subsequent improvement) may occur through a multi-step process including, but not necessarily limited to needs analysis, solution design and implementation, and evaluation.

The learning organization may utilize 6 substantially aligned and interdependent dimensions: information, resources, incentive, knowledge, capacity, and motivation. Embodiments of the present invention may apply each dimension site specifically, as prescribed according to need.

Yet, systems tend to be more dynamic than static. Change is inevitable, and introduction of ‘events,’ either individually or in tandem, tend to disrupt balance. Re-balancing the system requires a process of rapid, data-driven problem solving, which in turn, informs the organization, resulting in a continuous process of learning and improvement. Embodiments of the present invention allow a user (e.g., the learning organization) to monitor, further evaluate, and make changes to their system in order to address any changes that may occur in the organization.

As described in greater detail below, exemplary embodiments of the present invention may be utilized to manage safety, improve safety culture, and maximize the return on investment in safety and safety improvement. In general, some embodiments of the present invention consist of a three step process.

### Step 1: Formation of the Learning Organization

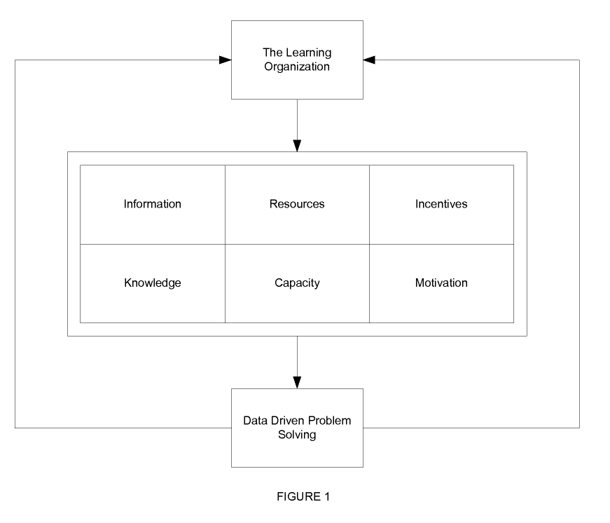

The initial step in embodiments of the present invention involve establishment of a learning organization, through which workers and management learn from both safety successes and failures. For example, the learning organization may be group of safety professionals, management professional, or other individuals with an interest in organization's safety that performs the following functions:
Needs Assessment: In conjunction with workers and management, the learning organization may engage in a safety audit, a hazard analysis, and a performance analysis, measuring the current state of safety against the model's six cultural/behavioral dimensions (e.g., as shown in FIG. 1). Data may be collected through a variety of methods: interviews with select representatives of management and labor; examination of extant records; surveys; and direct observation. Gaps in the system are identified, root causes for the gaps determined, a report of findings and recommendations for balancing the system is generated. Based on what has been learned about the operation, the learning organization may negotiate possible interventions, and a budget and ROI forecast for the project is developed.
Program Design: Based on the needs assessment, interventions may be developed to close the gaps between the current and the ideal safety system.
Program Implementation: The learning organization may direct the implementation of interventions, addressing each dimension individually, creating alignment and interdependence among dimensions.
Evaluation: The learning organization may assess the performance of the safety improvement program through the use of surveys, criterion referenced tests, and behavior based observation.

### Step 2: Maintenance of a Balanced Safety System

To maintain system balance, periodic evaluation may be conducted to detect new safety and performance issues, whenever new hazards are introduced into the workplace, and to ensure that the system is providing maximum bottom line impact.

### Step 3: Rapid Data-Driven Problem Solving

In the event evaluation points to an imbalance, a process of rapid, data-driven problem solving may be instituted. The data-driven problem solving may include:

Data Collection and Problem Identification

Gap and Root Cause Analysis

Solution Generation

Solution Design

Results from this process serve to inform the learning organization, and a strategy for re-balancing the system is implemented, thereby creating a continuous process of organizational improvement.

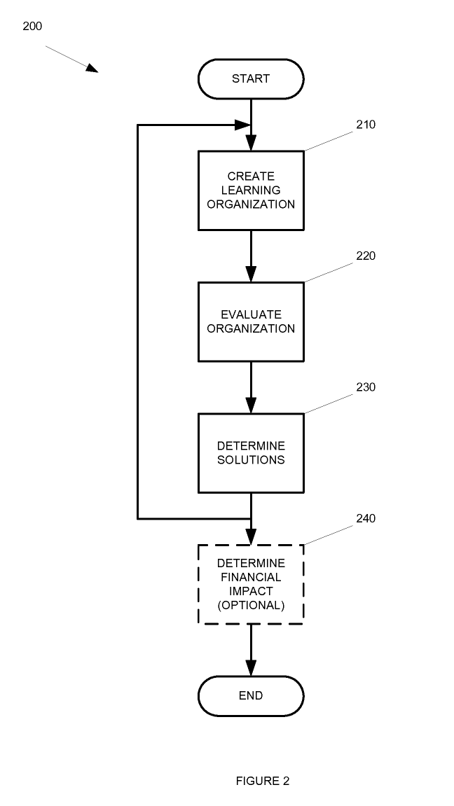

FIG. 2 shows a process flowchart of a method 200 for managing safety within in organization. The method 200 generally starts with creating a learning organization (Step 210), as described above. The learning organization and/or the method 200 may generate a first set of data, including information relating to the organization's safety performance and any existing safety issues. The first set of data can be generated in a variety of ways. For example, the data may be generated by performing interviews with members and employees of the organization, examining the organization's records (e.g., safety record, human resources records, employment records, financial records, incident reports etc.), surveying members and affiliates of the organization, directly observing the organization (e.g., the general work and safety practices, the types of processes and work conducted at the facility, etc.), and/or inputting the data into the website or the templates described below. It is important to note that in some embodiments, the first set of data may be generated by analyzing the organization's records and reports using an automated system. For example, the first set of data may be created using a computer system or the series of modules discussed in greater detail below. Once created, the learning organization allows the organization to learn from safety successes and safety failures, and maintain a balanced workplace safety performance.

After the learning organization is created (Step 210), the method 200 may then periodically evaluate the organization to detect and obtain information regarding new safety issues, new workplace procedure/practice, new workplace dangers, etc. The method may then generate a second set of data (Step 220). The second set of data may include information regarding the new safety issues. The method may also determine solutions to the existing new safety issues using the first and second data sets (Step 230). In accordance with some embodiments, the method 200 may also perform an optional additional step (e.g., Step 240). In particular, the method 200 may also determine the financial impact that the safety issues and implementation of the solutions have on the organization (Step 240). The financial impact on the organization will provide the organization with a way to evaluate the extent of its safety issues and evaluate the financial return that the implementation of the safety management system provides the company. The financial impact may be based on the determined solutions to the existing safety issues, the first set of data, the second set of data, loss of labor data, regulatory fines data, workers compensation data, and/or loss of productivity data.

It is important to note that, although the above described method is described as having multiple discrete steps, each of the above described steps may include a variety of sub-steps. For example, the method may include performing a needs assessment to generate the first set of data and identify the existing safety issues. The needs assessment may also identify gaps between the organization's safety performance and an ideal system (e.g., the system shown in FIG. 1). The needs assessment may include performing a safety audit, a hazard analysis, and/or a performance analysis to determine the current state of safety within the organization. Additionally, the needs assessment may compare the current state of safety against a variety of factors, including, but not limited to, cultural and behavioral factors (e.g., information, resources, incentives, knowledge, capacity, and motivation). The needs assessment may performed on site or may be performed remotely based upon the information/data inputted into the website, described below. Additionally or alternatively, as described in greater detail below, the needs assessment may be performed automatically by the software packages described below and based upon the data inputted in the data templates.

Additionally, the method may also include designing and implementing a safety program to address the gaps between the organization's safety performance and the ideal system. Further, the method may also include evaluating the creation of the learning organization to ensure that the learning organization has been achieved and is being maintained.

Moreover, the step of determining solutions to the safety issues (e.g., new, existing, and potential) may also include a variety of sub-steps. For example, the step of determining solutions (Step 230) may include identifying one or more problems with the organization's safety performance (e.g., by direct observation, safety and performance records, interviews with members of the organization, analysis of inputted data etc.), and/or conducting a cause analysis to determine the root cause of the problems. The cause analysis may generate cause data (e.g., data related to the cause of the problem) that may be used to develop a solution to the problem. The method may then develop a solution implementation procedure that aids the organization to implement the solution.

It is important to note that the above described method 200 may also be implemented as a continuous and repeatable method (e.g., it may be performed more than just a single time). In other words, the above described method 200 may be repeated at various time or event intervals (e.g., weekly, monthly, quarterly, after a safety incident, prior to implementing a new manufacturing or work-related process, etc.). The continuous nature of the method 200 allows the organization to continually review and evaluate its safety program and performance and update the existing plan and/or implement new plans prior to the occurrence of a major safety incident or implementation of a new work process.

Figure shown an embodiment of a system 300 in which the above described method may be implemented. The system 300 includes a global data communications network 320, such as the internet. The system 300 may also include a server 350 that is in communication with the global communications network 320. The server 350 may support a website 340. The website 340 may consist of a plurality of web pages. The system 300 may include one or more customer terminals 310/312/314, such as a workstations within the organization mentioned above, that are in communication with the global communications network 320. The website 340 may be accessed and displayed by the workstations 310/312/314 over the global communications network 320. Further, the workstation 310/312/314 may send information back to the server 350 over the global communications network 320. The system 300 may also include a safety management organization 330. The safety management organization 330 may access and view the website 340 and access any data stored within the server 350. The safety management organization 330 may also send information back to the server 350 over the global communications network 320.

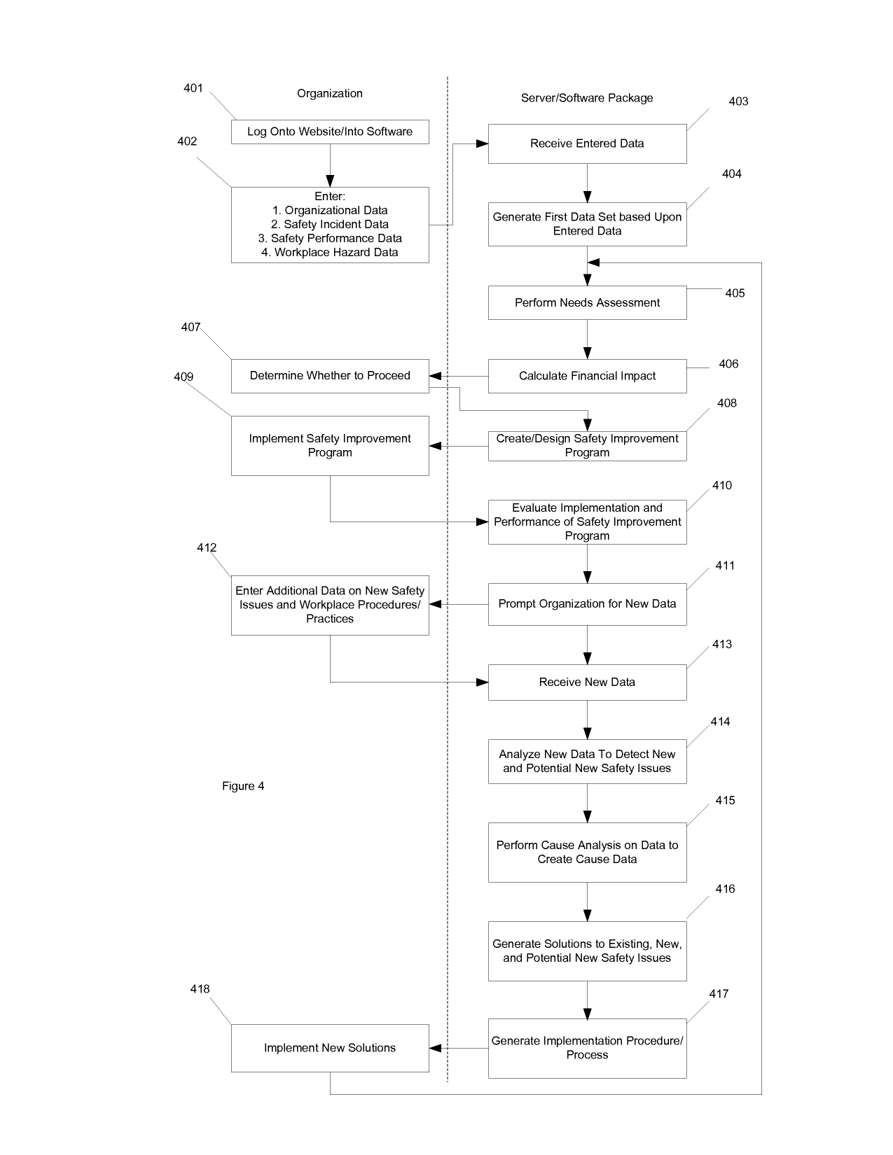

FIG. 4 shows a computerized method for safety management and improvement in accordance with additional embodiments of the present invention. In this embodiment, the learning organization described above may send information (402) from one or more of the worksites 310/312/314 by logging onto the website (401). For example, the learning organization may enter organizational data (e.g., name of organization, address, industry, number of employees, name and contact information for the individual(s) responsible for safety management within the organization, etc.), safety incident data (e.g., information/data regarding the type of incident or accident, the type and extent of injuries sustained, the number of employees involved and/or injured, any worker's compensation claims, any fines received by regulatory bodies, any lawsuits resulting from the incident, loss of work or productivity, etc.), safety performance data (e.g., number of days since the last incident, past safety performance, percentage of employees following safety procedures, etc.), and workplace hazard data (e.g., information relating to any hazardous chemicals, conditions, equipment, etc.).

Once the learning organization enters the required information, the server 350 may receive the entered data (403) and generate a first set of data based upon the entered data 404. The server 450 or other equipment within the safety management organization 330 (which is in communication with the server) may then perform a needs assessment by analyzing the first set of data (405). The needs assessment will generate information regarding existing safety issues, identify gaps within the organization's safety performance and procedures (e.g., by comparing to an ideal system), as well as other areas that should be addressed within the organization.

After performing the needs assessment, the server may then calculate the financial impact on the organization (406). The information obtained from the financial impact calculation will provide the learning organization with information required to determine whether or not to proceed with developing and implementing new safety programs, for example. The server may calculate the estimated costs for implementing the new procedures and addressing the gaps within the safety procedures and performance, as well as, calculate the estimated cost savings (e.g., from decreased workers compensation, decreased insurance rates, decreased regulatory fines, decreased loss in production/shut-down time, etc.). The learning organization may then, based upon this information, determine whether there is a solid business case for proceeding with the next steps (407).

If the learning organization determines that proceeding is a sound business and financial decision, the server may then create and design a safety program (408) that addresses the issues, problems, needs, and gaps discovered during the needs assessment and forward this safety program to the learning organization where it may be implemented (409). During the implementation process (409), the server may evaluate the progress of the implementation (410) to ensure that the program is being implemented and the performance of the safety improvement program.

As mentioned above, safety management is not a static task. As the organization continues to operate, new safety hazards, work procedures/tasks, incidents, and other changes may develop. To that end, the server may periodically prompt (e.g., by sending an e-mail alert or otherwise contacting the organization) to enter new data similar to that described above (e.g., new incident and injury data, new work procedures and tasks, new hazards, etc.) (411). In response to this prompt, the learning organization may then enter the requested additional data (412) and the server may receive this information (413).

Once the new information is received, the server may create a second data set and analyze the new data to detect new and potential safety issues (414). The server may also analyze the first data set, the second data set, and any additional information, and perform a cause analysis to determine the root cause of the new safety issues and gaps (415). In a manner similar to that described above, the server may generate solutions to the existing, new, and potential safety issues (416) and create/generate an implementation procedure or process (417) that may be sent to and implemented by the learning organization (418).

Once the solutions have been received and implemented by the learning organization (418), some embodiments of the present invention may also be able to provide the learning organization with additional financial impact information. For example, the computerized method may recalculate the financial impact on the organization to provide the organization with information regarding the cost saving resulting from addressing their safety issues and gaps. Additionally, as shown in FIG. 4, the computerized method may repeat steps 405-418 in order to provide on-going safety management and solutions.

It is important to note that, in order to facilitate the input of the required data and information, the website may present the user/organization with a graphical interface that includes series of templates. The user/organization may then simply fill in the necessary information by, for example, manually typing in the information, selecting it from a drop down menu, clicking a button, and/or checking a box.

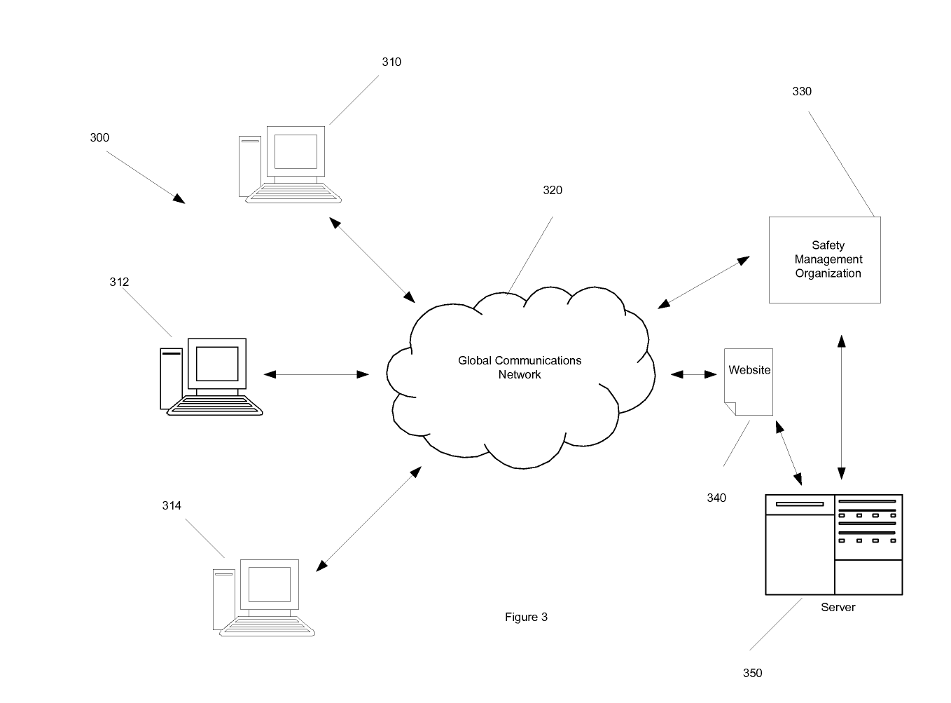

In accordance with other embodiments, the invention may be implemented as a computer program product for use with a computer system, such as the workstations 310/312/314 shown in FIG. 3. Such implementation may include a series of computer instructions fixed either on a tangible medium, such as a computer readable media (e.g., a diskette, CD-ROM, ROM, or fixed disk), or transmittable to a computer system via a modem or other interface device, such as a communications adapter connected to a network over a medium. The medium may either be a tangible medium (e.g., optical or analog communications lines) or a medium implemented with wireless techniques (e.g., microwave, infrared or other transmission techniques). The series of computer instructions embodies all or part of the functionality previously described herein with respect to the system. For example, the series of computer instructions may be a computer program that may be installed on one or more of the organization's workstations 310/312/314. The installed program may then perform the functions described in relation to the server 350. For example, the software program may present the user with a graphical interface and a serries of templates to facilitate the necessary data input. The software program may then generate the required data sets, perform the needs assessment, calculate the financial impacts, create/design the safety programs, evaluate the implementation of the program, prompt the organization for and receive the new data, analyze the new data for new issues, conduct the cause analysis, and generate the solutions and implementation procedure/process.

Those skilled in the art should appreciate that such computer instructions/software programs can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable media with accompanying printed or electronic documentation (e.g., shrink wrapped software), preloaded with a computer systems (e.g., on system ROM or fixed disk), or distributed from a server or electronic bulletin board over the network (e.g., the Internet or World Wide Web).

Although the above discussion discloses various exemplary embodiments of the invention, it should be apparent that those skilled in the art can make various modifications that will achieve some of the advantages of the invention without departing from the true scope of the invention.

What is claimed is:

1. A computerized method of safety improvement and management within an organization comprising:
receiving a first set of data from the organization over a global communication network, the first set of data including at least one of organizational data, safety incident data, safety performance data, and workplace hazard data;
performing, within a computer process, a needs assessment for the organization by analyzing the first set of data, the needs assessment generating information regarding at least one of existing safety issues, gaps within the organization's safety performance, and gaps within the organization's safety procedures;
creating, within a computer process, a safety improvement program for the organization, the safety program being based, at least in part upon the needs assessment and including solutions to the existing safety issues and/or gaps within the organization's safety performance and procedures.

2. A computerized method according to claim 1, further comprising:
evaluating, within a computer process, the implementation and performance of the safety improvement program.

3. A computerized method according to claim 1, further comprising:
calculating, within a computer process, a financial impact on the organization, the financial impact on the organization including at least one of estimated costs for program implementation, estimated costs for addressing the gaps within the organization's safety performance and/or procedures, and estimated costs savings once the program is implemented.

4. A computerized method according to claim 1, further comprising:
automatically prompting the organization for new data, the new data including at least one of updated safety incident data, updated safety performance data, and new workplace hazard data;
receiving the new set of data from the organization over a global communication network; and
analyzing, within a computer process, the new data to determine new and potential safety issues and gaps.

5. A computerized method according to claim 5, further comprising:
automatically generating, within a computer process, solutions to the new and potential safety issues;
generating, within a computer process, a solution implementation procedure, the solution implementation procedure helping the organization implement the solutions to the new and potential safety issues; and
transmitting, over the global communications network, the solution implementation procedure to the organization, whereby the organization may perform the solution implementation procedure.

6. A computerized method according to claim 5, further comprising:
performing, within a computer process, a cause analysis on the new data to determine a root cause of the new safety issues and gaps, the solutions to the new and potential safety issues being based, at least in part, upon the root cause of the new safety issues and gaps.

7. A system for managing workplace safety comprising:
means for creating a learning organization within an organization, wherein the learning organization generates a first set of data, the first set of data including information related to the organization's safety performance and existing safety issues, the learning organization allowing the organization to learn from safety successes and safety failures and maintain balanced workplace safety performance;
means for periodically evaluating the organization to detect new safety issues and generate a second set of data, the second set of data including information regarding the new safety issues; and
means for determining solutions to existing safety issues and new safety issues using the first and second data sets.

8. A method according to claim 7 further comprising:
means for performing a needs assessment, the means for performing a needs assessment generating the first set of data and identifing the existing safety issues and gaps between the organization's safety performance and an ideal safety system;
means for designing a safety improvement program to address the gaps between the organization's safety performance and the ideal safety system;
means for implementing the safety program to achieve the learning organization;
means for evaluating the implementation and performance of the safety improvement plan.

9. A system according to claim 8, wherein the means for performing a needs assessment further comprises:
means for performing at least one of a safety audit, a hazard analysis, and a performance analysis to determine a current state of safety; and
means for comparing the current state of safety against at least one of a plurality of cultural and behavioral factors.

10. A system according to claim 9, wherein the plurality of cultural and behavioral factors include at least one selected from the group consisting of: information, resources, incentives, knowledge, capacity, and motivation.

11. A system according to claim 7, wherein the means for determining solutions to existing safety and new safety issues further comprises:
means for identifying at least one problem within the organization's safety performance;
means for conducting a cause analysis to determine the root cause of the at least one problem within the organization's safety performance, the means for conducting a cause analysis generating cause data;
means for developing a solution to the at least one problem using the cause data; and
means for developing a solution implementation procedure, the solution implementation procedure allowing the organization to implement the solution to the at least one problem.

12. A system according to claim 7, wherein the means for determining solutions also calculates a financial impact on the organization, the financial impact being based, at least in part, upon the determined solutions to existing safety issues and the first set of data.

13. A system according to claim 12, wherein the financial impact is further based upon the second set of data in addition to the determined solutions to existing safety issues and the first set of data.

14. A computer program product for use on a computer system for managing workplace safety within an organization, the computer program product comprising a computer usable medium having computer readable program code thereon, the computer readable program code comprising:
program code for creating a learning organization within an organization, the program code for creating the learning organization generating a first set of data, the first set of data including information related to the organization's safety performance and existing safety issues, the program code for creating a learning organization allowing the organization to learn from safety successes and safety failures and maintain balanced workplace safety performance;
program code for periodically evaluating the organization to detect new safety issues and generating a second set of data, the second set of data including information regarding the new safety issues; and
program code for determining solutions to existing safety issues and new safety issues using the first and second data sets.

15. A computer program product according to claim 14 further comprising:
computer code for performing a needs assessment to generate the first set of data and identify the existing safety issues and gaps within the organization's safety performance;
computer code for designing a safety improvement program to address the gaps within the organization's safety performance;
computer code for implementing the safety improvement program; and
computer code for evaluating the implementation and performance of the safety improvement program.

16. A computer program product according to claim 15, wherein the computer code for performing a needs assessment includes:
computer code for performing at least one of a safety audit, a hazard analysis, and a performance analysis to determine a current state of safety; and
computer code for comparing the current state of safety against at least one of a plurality of cultural and behavioral factors.

17. A computer program product according to claim 16, wherein the plurality of cultural and behavioral factors include at least one selected from the group consisting of: information, resources, incentives, knowledge, capacity, and motivation.

18. A computer program product according to claim 14, wherein the computer code for determining solutions to existing safety and new safety issues includes:
computer code for identifying at least one problem within the organization's safety performance;
computer code for conducting a cause analysis to determine a root cause of the at least one problem within the organization's safety performance, the cause analysis generating cause data;
computer code for developing a solution to the at least one problem based, at least in part, upon the cause data; and
computer code for developing a solution implementation procedure, the solution implementation procedure allowing the organization to implement the solution to the at least one problem.

19. A computer program product according to claim 14 wherein the first set of data is collected through at least one of: analyzing the organization's records and reports within a computer process, and receiving data input by the organization into at least one user interface template within a graphical interface.

20. A computer program product according to claim 14 further comprising:
computer code for determining a financial impact on the organization, the financial impact being based upon at least one selected from the group consisting of: the determined solutions to existing safety issues, the first set of date, and the second set of data.
